(19) United States
(12) Patent Application Publication
(10) Pub. No.: US 2003/0234809 A1
(43) Pub. Date: Dec. 25, 2003

(54) Method and system for remotely operating a computer

(76) Inventors: Kathryn L. Parker, Sammamish, WA (US); Martin R. Calsyn, Carnation, WA (US); William T. Flora JR., Seattle, WA (US); Jeffrey C. Fong, Seattle, WA (US); Gopala Krishna R. Kakivaya, Sammamish, WA (US); Molly Scoville Rhoten, Seattle, WA (US); Mark Jeffrey Weinberg, Kirkland, WA (US); Bryan A. Woodruff, Redmond, WA (US)

Correspondence Address: SHOOK, HARDY & BACON, 1200 MAIN STREET, ONE KANSAS CITY PLACE, KANSAS CITY,, MO, 64105-2118, US

(21) Appl. No.: 10/174,707

(22) Filed: Jun. 19, 2002

(51) Int. Cl. G09G 5/00

(52) U.S. Cl. 345/740; 345/864

(57) ABSTRACT

A method and system for operating a computer remotely whereby a hand-held device is used to input commands to control the computer. A logical connection is established within a network computing environment between the hand-held device and the computer. Client and server applications are started that facilitate two-way communication between the computer and the hand-held device. Media devices and entertainment devices connected to the computer can also be controlled by the hand-held device.

### CROSS-REFERENCE TO RELATED APPLICATIONS

Not applicable.

### STATEMENT REGARDING FEDERALLY SPONSORED RESEARCH OR DEVELOPMENT

Not-applicable.

### TECHNICAL FIELD

The present invention relates to operating computers remotely. More particularly, the present invention provides a method and apparatus for enabling the operation of a personal computer from a remote location using a hand-held device.

### BACKGROUND OF THE INVENTION

Although a trend is developing to move the personal computer (PC) from the home office to the living room, some people still enjoy keeping the PC out of the living room. Even those who do not want a PC to be a focal point in the living room would like to be able to operate their computer remotely.

Recently, Personal Data Assistants (PDAs) have become popular devices. These devices offer a variety of features that add value to customers. PDAs are known by many names such as “palm-top computers” and Personal Information Managers (PIMs). The term “hand-held device” or “hand-held” is used herein to collectively refer to the various devices that offer mobile computing functionality. A POCKET PC is a hand-held device that employs a version of the WINDOWS Operating System produced by the Microsoft Corporation of Redmond, Wash.

POCKET PCs are produced by HP, Compaq, Toshiba, and Casio among others. A POCKET PC includes a graphical user interface and allows users to store contact information, generate documents, browse the Internet, transfer e-mails, and a myriad of other functions. Another popular hand-held is the PALM PILOT, produced by Palm, Inc., of Santa Clara, Calif. The Palm line of hand-helds offers functionality similar to that of the POCKET PC.

As much functionality as hand-helds currently offer, there is still a limit. Some of the aspects that make PDAs attractive impose constraints on the extent of their functionality. People rely heavily on PDAs because of their compact size and ergonomic designs. Compact size, however, results in processing-power limitations. Often, consumers must sacrifice the processing power of a full-sized computer in their hand-held devices. For those who would rather retain the isolation of their PCs in the home, it would be advantageous to operate a computer remotely from a hand-held device. Operating a computer from a hand-held device would abrogate the need to choose size at the expense of processing power. Accordingly, there is a need for a method, system, and product that permits a computer to be remotely operated using a hand-held device.

### SUMMARY OF THE INVENTION

The present invention has several practical applications in the technical arts. The present invention allows users to control a PC using a hand-held device in a fashion similar to a remote control. The present invention can be used to play media on a hand-held device where the media is located on a PC, to make such media portable, to control components connected to the PC, and to run any program on the PC.

In one aspect of the invention, a method is provided for remotely operating a computer by logically coupling a hand-held device to a computer. A user interface is presented on the hand-held device for controlling the computer. The reception of control commands transmitted from the hand-held device is made possible so that the hand-held device can be used to control the computer.

In another aspect of the invention a system for remotely controlling a computer and components connected to the computer is provided. The system includes a computer equipped with a transceiving device and a hand-held device logically coupled to the computer. A server application for transmitting and receiving commands to and from the hand-held device runs on the computer and a client application for transmitting and receiving commands to and from the server computer runs on the hand-held device. The computer and components connected to it can be controlled via commands issued from the hand-held device.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIG. 2 is a block diagram of a hand-held device suitable for use in implementing the present invention;

FIG. 2A is a diagram of an exemplary operating environment for practicing the present invention;

FIG. 2B is a functional diagram of an exemplary networking environment for practicing the present invention;

FIG. 2C is a block diagram of an exemplary extended networking environment for practicing the present invention;

FIG. 3 is a flow diagram of an exemplary process for practicing the present invention;

FIG. 4 is a diagram of an exemplary hand-held user interface; and

FIG. 4A is a screen shot of an exemplary hand-held user interface.

### DETAILED DESCRIPTION OF THE INVENTION

The present invention is a method and system for operating a computer remotely. A hand-held device is used to input commands to control a computer. A logical connection is established in a network environment between the hand-held device and the computer. Client and server applications are started that facilitate two-way communication between the computer and the hand-held device. Media devices and entertainment devices connected to the computer can also be controlled by the hand-held device. A more in depth description of the present invention will be provided below. An exemplary operating environment for the present invention is described below.

### Computing System Environment

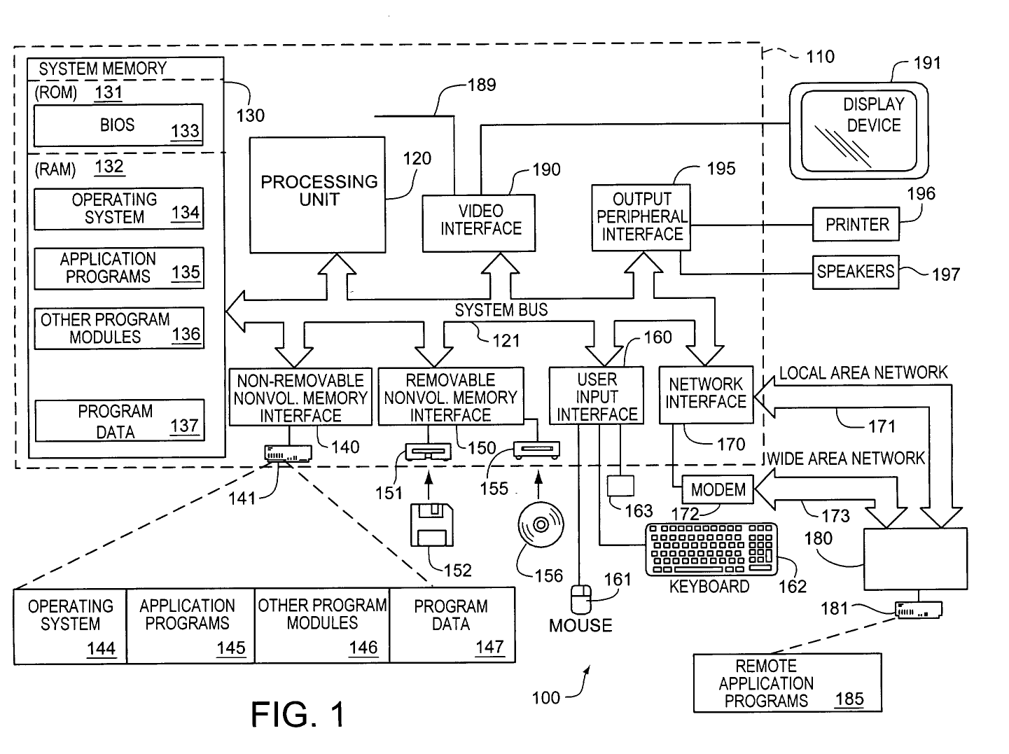

Referring to the drawings in general and initially to FIG. 1 in particular, wherein like reference numerals identify like components in the various figures, an exemplary operating environment for implementing the present invention is shown and designated generally as operating environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including hand-held devices, multiprocessor systems, microprocessor-based or programmable consumer electronics, minicomputers, mainframe computers, and the like. The invention may also be practiced in a distributed computing environment where tasks are performed by remote processing devices that are linked through a communications network. In a distributed computing environment, program modules may be located in both local and remote computer storage media including memory storage devices.

With reference to FIG. 1, an exemplary system 100 for implementing the invention includes a general purpose computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. Examples of computer storage media include, but are not limited to, RAM, ROM, electronically erasable programmable read-only memory (EEPROM), flash memory or other memory technology, CD-ROM, digital versatile disks (DVD) or other optical or holographic disk storage, magnetic cassettes, magnetic tape, magnetic disk storage or other magnetic storage devices, or any other medium which can be used to store the desired information and which can be accessed by computer 110. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media; a magnetic disk drive 151 that reads from or writes to a removable, nonvolatile magnetic disk 152; and an optical disk drive 155 that reads from or writes to a removable, nonvolatile optical disk 156 such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid-state RAM, solid-state ROM, and the like. The hard disk drive 141 is typically connected to the system bus 121 through a nonremovable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Typically, the operating system, application programs and the like that are stored in RAM are portions of the corresponding systems, programs, or data read from hard disk drive 141, the portions varying in size and scope depending on the functions desired. Operating system 144, application programs 145, other program modules 146, and program data 147 are given different numbers here to illustrate that, at a minimum, they are different copies. A user may enter commands and information into the computer 110 through input devices such as a keyboard 162; pointing device 161, commonly referred to as a mouse, trackball or touch pad; and an infrared transceiver 163. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A display device 191 is also connected to the system bus 121 via an interface, such as a video interface 190. Video interface 190 could also accept an incoming video signal 189. Display device 191 can be any device to display the output of computer 110 not limited to a monitor, an LCD screen, a TFT screen, a flat panel display, a conventional television, or screen projector. In addition to the display device 191, computers may also include other peripheral output devices such as speakers 197 and printer 196, which may be connected through an output peripheral interface 195.

The computer 110 in the present invention will operate in a networked environment using logical connections to one or more remote computers or hand-held devices, such as a remote computer 180. The remote computer 180 may be a personal computer and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173 but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. For example, including various expansion cards such as television tuner cards and network interface cards within a computer 110 is conventional. Accordingly, additional details concerning the internal construction of the computer 110 need not be disclosed in connection with the present invention.

When the computer 110 is turned on or reset, the BIOS 133, which is stored in the ROM 131, instructs the processing unit 120 to load the operating system, or necessary portion thereof, from the hard disk drive 141 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

### System and Method for Operating a Computer Remotely

As previously mentioned, the present invention may be described in the general context of computer-executable instructions such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

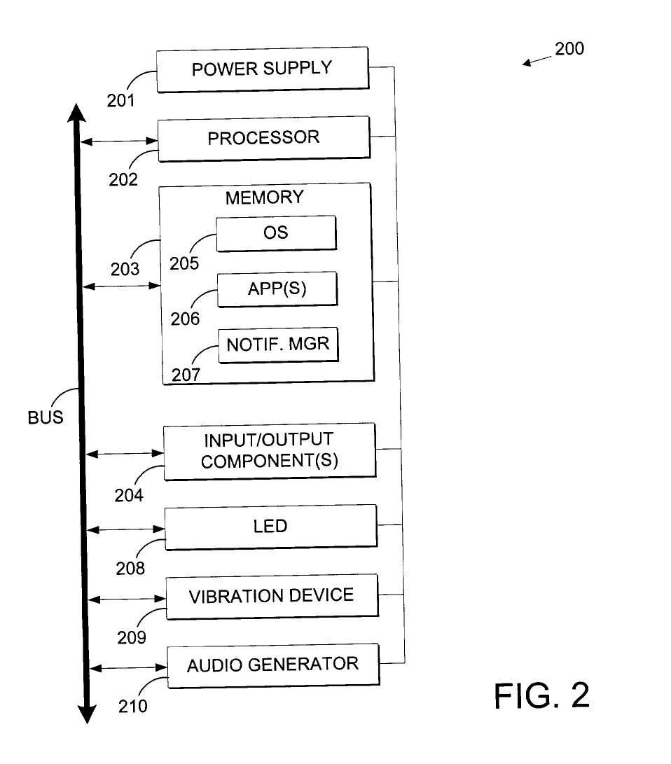

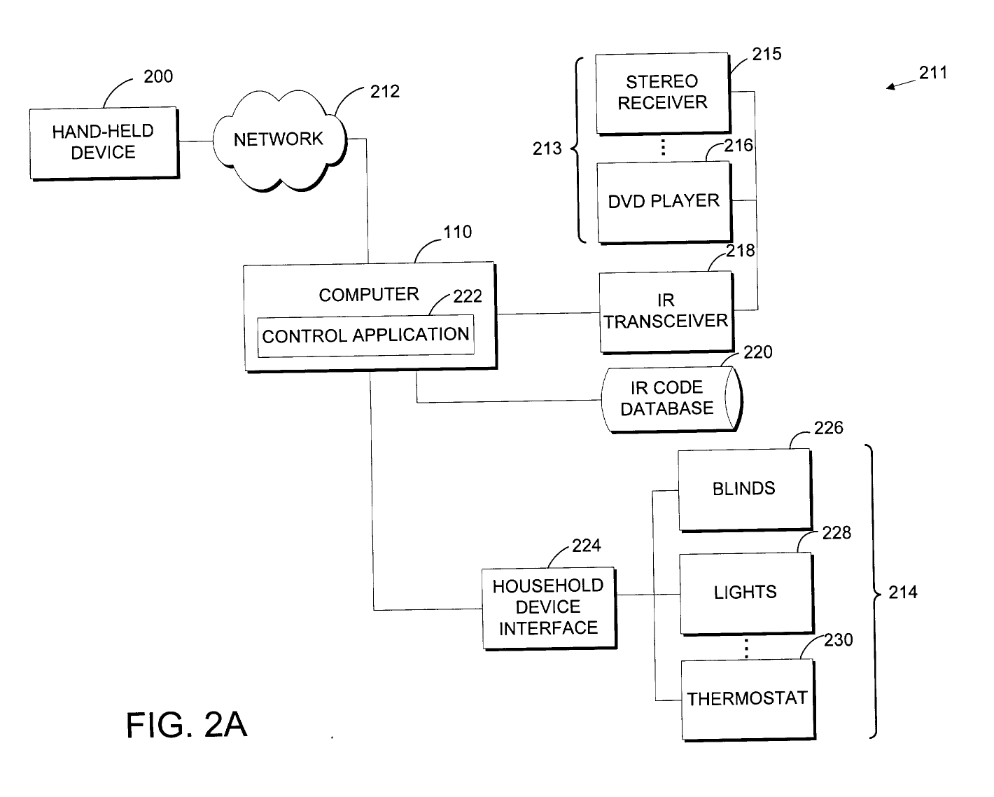

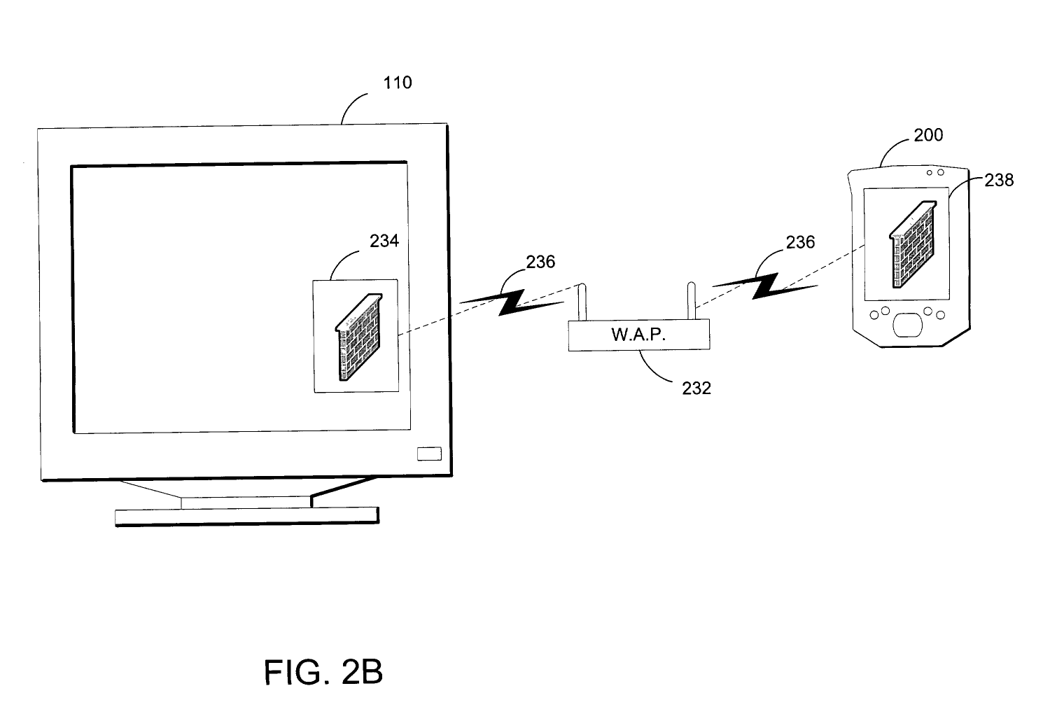

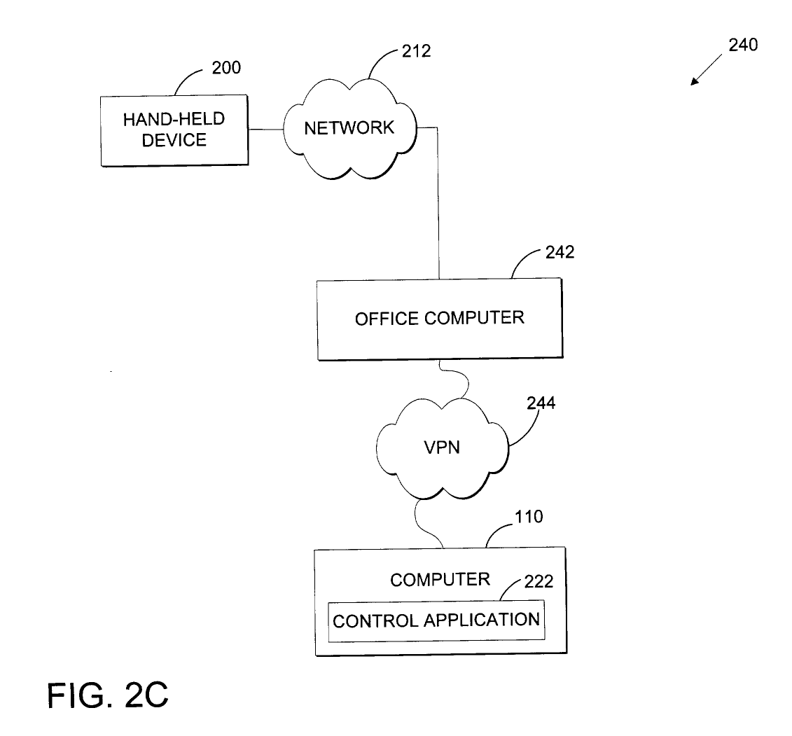

Turning now to FIG. 2, a block diagram of an exemplary hand-held device is referenced generally by the numeral 200. FIG. 2 shows functional components of hand-held device 200. It has a power supply 201, a processor 202, a memory 203, and one or more input/output (I/O) components 204. Typical I/O components 204 include a display with a touchscreen, a keypad, or an audio command processing component for responding to voice activated commands. The memory 203 generally includes both volatile memory (e.g. RAM) and nonvolatile memory (e.g., ROM, PCMCIA cards, smart media, compact flash, memory sticks, etc.). An operating system 205 is resident in the memory 203 and executed on the processor 202. The hand-held device includes an operating system such as the WINDOWS CE operating system from Microsoft Corporation or other operating system.

One or more application programs 206 are loaded into memory 203 and run on the operating system 205. Examples of applications include email programs, scheduling programs, word processing programs, spreadsheet programs, gaming programs, Internet browser programs, and so forth. The hand-held device 200 also has a notification manager 207 loaded in memory 203, which executes on the processor 202. The notification manager 207 handles notification requests from the applications 206.

The hand-held device 200 has a power supply 201, which can be implemented in a variety of ways including as one or more batteries. The power supply 201 might further include an external power source that overrides or recharges a built-in power source, such as an AC adapter or a powered docking cradle.

The hand-held device 200 is also shown with three types of external notification mechanisms: a Light Emitting Diode (LED) 208, a vibration device 209, and an audio generator 210. These devices are directly coupled to the power supply 201 so that when activated they remain on for a duration dictated by the notification mechanism, even though the hand-held device processor 202 and other components might shut down to conserve battery power. The LED 208 preferably remains on indefinitely until the user takes action. The current versions of the vibration device 209 and audio generator 210 use too much power for today's hand-held device batteries. They are often configured to turn off when the rest of the system does or at some finite duration after activation.

Turning now to FIG. 2A, an exemplary system environment for practicing the present invention is referenced generally by the numeral 211. A hand-held device 200 is logically coupled with computer 110. One of ordinary skill in the art will appreciate that logically coupling hand-held device 200 with computer 110 can be accomplished in a variety of ways. For example, hand-held device 200 can be tethered to computer 110 via a Universal Serial Bus (USB) cable, an IEEE 1394 (Firewire) cable, or other similar cable. An exemplary method of coupling hand-held device 200 with computer 110 is via a network, such as network 212. In a preferred embodiment, network 212 is a wireless network.

Using a wireless network, hand-held device 200 is coupled to computer 110 with no wires and allows a user to roam freely throughout his or her home while retaining a communication link. Wireless networks can be created in a variety of ways. Wireless network 212 could utilize infrared technology or a technology known as Bluetooth. In a preferred embodiment, network 212 is a conventional IEEE 802.11b network. In an 802.11b network, data is encoded using direct-sequence spread-spectrum (DSSS) technology. DSSS works by taking a data stream of zeros and ones and modulating it with a second pattern, the chipping sequence. In 802.11, that sequence is known as the Barker code, which is an 11-bit sequence (10110111000) that has certain mathematical properties making it ideal for modulating radio waves. The basic data stream is used with the Barker code to generate a series of data objects that facilitate wireless communication. Although an 802.11b network is the preferred operating environment, any other wireless protocol such as 802.11 a, is contemplated by the present invention.

A group of media components 213 and household devices 214 can also be coupled to computer 110 to be controlled by computer 110, such as a stereo receiver 215 and a DVD player 216. Media devices can be connected to computer 110, such as a television, a video player, a video recorder, an audio player, an audio recorder, a camera, a secondary computer, and a gaming console, etc. Media components are often manufactured by different manufacturers. Different manufacturers often use different infrared codes to control their devices. Generally, each manufacturer uses specific IR codes to control the features of its equipment. “Fast Forward” on a device made by the Sony Corporation may require a different IR code than “Fast Forward” on a device made by the Samsung Corporation. Thus, to be able to control an array of devices from computer 110, a database of IR codes 220 is provided.

IR code database 220 is connected to computer 110 to allow communication and control of the various media devices 213. Many other media devices such as CD players, minidisc players, phonographs or tape cassette players could also be connected to computer 110. A control application 222 running on computer 110 provides the functionality for controlling media devices 213 via computer 110. In a preferred embodiment, an infrared transceiver (IR transceiver) 218, is connected to computer 110. IR transceiver 218 is conventional in nature and is used to transmit infrared signals throughout a home to various components such as DVD player 216 and stereo receiver 215. An exemplary IR transceiver 218 suitable for use in the present invention is the “Slink-e” device made by Nirvis Systems of Kensington, Calif. The Slink-e device connects to computer 110 via an RS-232 serial interface to send and receive IR commands. The IR transceiver 218 and IR code database 220 need not be separate components. In an alternative embodiment, both components can reside and be part of computer 110.

More devices than merely media components 213 could be controlled by computer 110. Using a household interface device 224 connected to computer 110, items such as blinds 226, lights 228, and thermostat 230 could also be controlled via computer 110. One of ordinary skill in the art will appreciate that a variety of devices not shown could also be controlled via computer 110 with household device interface 224.

The control application 222 running on computer 110 allows a user to control the different components coupled to the computer from the hand-held device 200. In order to allow remote-control operation of computer 110, hand-held device 200 is placed in communication with computer 110 via network 212.

The spirit of the present invention is to be able to remotely control computer 110 from hand-held device 200. This can be accomplished in a variety of ways on a variety of devices. An example follows wherein hand-held device 200 is a POCKET PC and is placed in communication with computer 110 via a network protocol known as Terminal Services offered by The Microsoft Corporation of Redmond, Wash. Those of ordinary skill in the art, however, will appreciate that hand-held device 200 need not be a POCKET PC and that other alternatives of placing hand-held device 200 in communication with computer 110 can be accomplished by other means than using Terminal Services.

As mentioned above, in a preferred embodiment hand-held device 200 remotely controls computer 110 using Terminal Services. Terminal Services is a software program product that allows the client to connect to a remote host via a network and to emulate the profile required by the host application. Emulating the profile of the host application includes emulating the keyboard and screen characteristics required by the host application. Terminal services provides functionality similar to a terminal-based, centralized host, or mainframe environment in which multiple terminals connect to a host computer. Each terminal provides a conduit for input and output between a user and the host computer. A user can log on at a terminal and then run applications on the host computer, accessing files, databases, network resources and so on. Each terminal session is independent, with the host operating system managing conflicts between multiple users contending for shared resources.

In a preferred embodiment, a control application 222 runs on computer 110. Also running on computer 110, is the Terminal Services server. The Terminal Services client, which runs on the hand-held device 200, performs very little or no local processing of control application 222. The server computer 110 transmits the graphical user interface to the hand-held device 200. The hand-held device 200 transmits the user's input back to the computer 110. Employing Terminal Services offers the advantage of a thin client application. That is, very little processing power is required from the hand-held device 200.

An illustration of using Terminal Services is provided in FIG. 2B. As illustrated in FIG. 2B, a wireless access point 232 is used to transmit a control application user interface 234 from computer 110 to hand-held device 200 via a transmission signal 236. The transmission signal 236 facilitates two-way communication between computer 110 and hand-held device 200. The topology illustrated in FIG. 2B allows for a thin client application, Terminal Services client, to be run on the hand-held device 200. In a preferred embodiment, Terminal Services client runs on hand-held device 200, and Terminal Services server runs on computer 110 to provide the functionality that enables inputs from hand-held device 200 to control the operation of computer 10, which in turn allows for the remote control of the various components 213 and 214 connected to computer 110. Control application user interface 234 has a screen resolution to match the screen resolution of hand-held device 200, 240×320 pixels for example.

Using the present invention, a user observes a hand-held device user interface 238, which is a projection of the control application user interface 234 residing and running on computer 110. Commands entered via hand-held device user interface 238 control the operation of computer 110. To turn on a stereo-receiver 215 using hand-held device 200, a user remotely controls computer 110, which has stereo-receiver 215 coupled to it, to send a command that turns on stereo-receiver 215. Rich control over media devices 213 is facilitated by IR database 220. A user is able to turn the volume up or turn the volume down, switch CDs, turn on or turn off the television, play a DVD movie, etc., all from hand-held device 200. The present invention is not limited to running control application 222 via hand-held device 200.

Any program running on computer 110 could be controlled remotely from hand-held device 200. That is, any functionality that can be accomplished at computer 110, such as creating a word-processing document, sending a facsimile, composing an e-mail, browsing the Internet, or playing a game could likewise be carried out remotely via hand-held device 200. Using a remote access utility or a virtual private network, a user would be able to control his or her home PC from the office.

Turning now to FIG. 2C, an exemplary system for remotely controlling a home computer from an office location is provided and referenced generally by the numeral 240. In FIG. 2C, hand-held device 200 is logically coupled to office computer 242 via a network 212. Office computer 242 is then connected to home computer 110 via a Virtual Private Network (VPN) 244 or some other Remote Access Service. The VPN 244 allows office computer 242 to control home computer 110. This embodiment allows a user at the office to turn down the thermostat at home using hand-held device 110. A control application 222 still runs on computer 110. The user interface of computer 110 is presented on office computer 242 and then transmitted via network 212 to hand-held device 200 using Terminal Services. One of ordinary skill in the art would appreciate a myriad of other topologies wherein the present invention could be practiced.

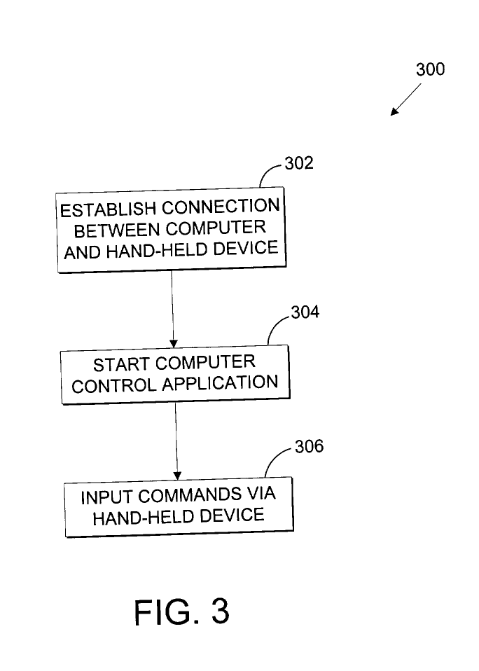

Turning now to FIG. 3. An exemplary process for practicing the present invention is referenced generally by the numeral 300. The steps listed in FIG. 3 do not need to be carried out in the order shown but are shown in an order provided for illustrative purposes only. At a step 302, a user establishes a connection between computer 110 and hand-held device 200. As previously described, such a connection could be established using a wireless network 212 and Terminal Services, running Terminal Services Client on the hand-held device 200 and Terminal Services Server on computer 110. Next, or even before step 302, a user could start the control application 222 at a step 304. Establishing a network connection and starting control application 222 allows a user to input commands via the hand-held device 200 at a step 306 whereby computer 110 is controlled in response to the issued commands.

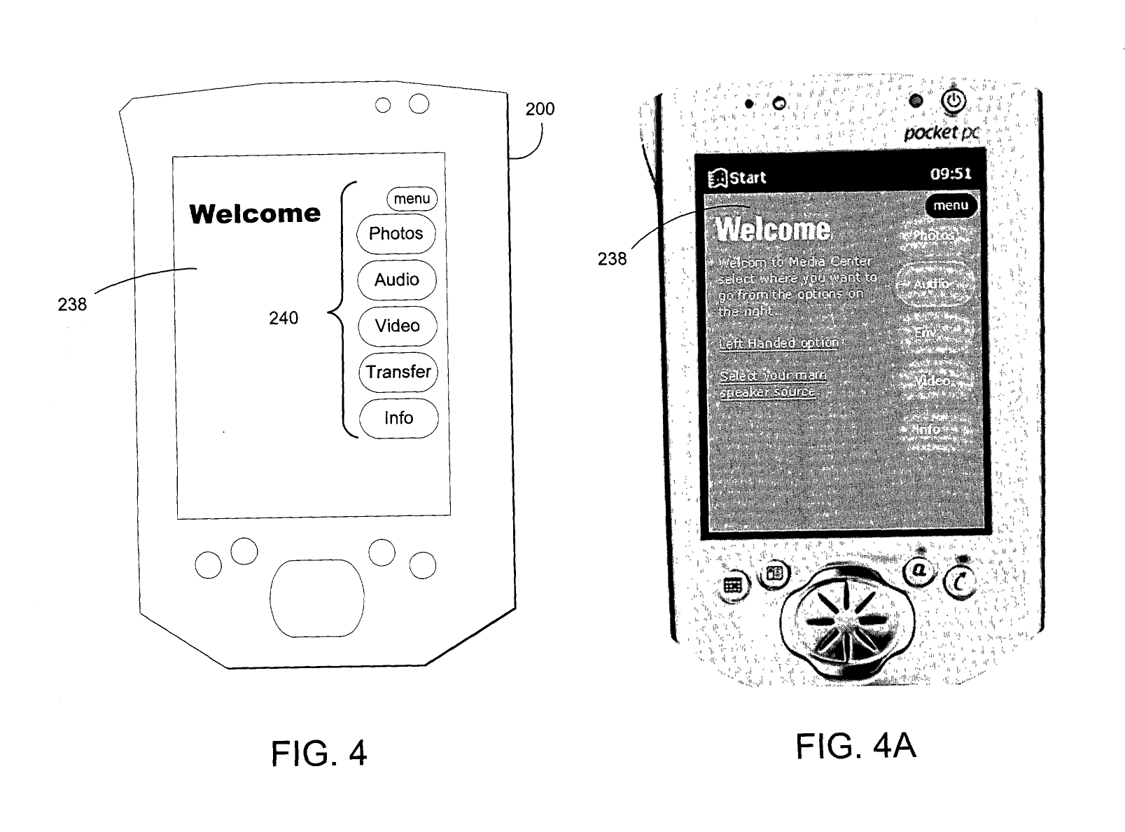

Turning now to FIG. 4, an exemplary hand-held user interface 238 is provided. Hand-held user interface 238 includes a group of selectable links 240 for controlling the content displayed on hand-held user interface 238. Using the selectable links 240, a user can view photos or listen to an audio track on computer 10 for example. The present invention also allows users to take with them media content stored on computer 10. For example, users can transfer a photo from computer 10 to hand-held device 200, or transfer an audio track stored on computer 110 onto hand-held device 200. A screen-shot 240 of hand-held user interface 238 is provided in FIG. 4A.

As can be seen, the present invention is well adapted to providing the remote operation of a personal computer via a hand-held device. Coupling any number of hand-held devices to a computer 110 in any of a variety of ways is possible without departing from the spirit and scope of the present invention; remotely operating a computer via a hand-held device.

The present invention has been described in relation to particular embodiments, which are intended in all respects to be illustrative rather than restrictive. Alternative embodiments will become apparent to those skilled in the art to which the present invention pertains without departing from its scope. For example, control application 222 could run on hand-held device 200, whose commands would still be transmitted to computer 110 via network 222 whereby components connected to computer 110 can be controlled. This exemplary alternative embodiment would be accomplished by executing a user interface presentation module locally on the hand-held device without the need to transmit a user interface from computer 110.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What the invention claimed is:

1. A method for remotely operating a computer, comprising:
providing for the logical coupling of a hand-held device to the computer;
providing for the presentation of a user interface on the hand-held device for controlling the computer; and
providing for the reception of control commands transmitted from the hand-held device whereby the computer responds to the reception of the control commands.

2. The method of claim 1, wherein the providing for the logical coupling of a hand-held device to the computer comprises:
enabling the computer to be connected to a network; and
enabling the hand-held device to be connected to the network.

3. The method of claim 2, wherein enabling the computer to be connected to the network includes enabling the computer to be connected to a wireless network.

4. The method of claim 1, wherein the providing for the presentation of a user interface on the hand-held device includes:
running a server application on the computer for transmitting a user interface to the hand-held device and for receiving commands from the hand-held device; and
running a client application on the hand-held device for receiving the user interface and transmitting commands to the computer.

5. The method of claim 1, wherein providing for the reception of control commands includes providing for the transfer of a file on the computer to the hand-held device.

6. The method of claim 1, further comprising providing for a coupling of a plurality of components to the computer, wherein the computer response to the reception of the control commands includes controlling one of the plurality of components coupled to the computer.

7. The method of claim 6, wherein the components are media components.

8. The method of claim 7, wherein the media components are selected from a group consisting of the following: a television, a video player, a video recorder, an audio player, an audio recorder, a camera, a secondary computer, and a gaming console.

9. The method of claim 8, wherein the components are household components.

10. The method of claim 9, wherein the household components are selected from a group consisting of the following: a temperature control device, a refrigeration device, a set of window blinds, a light, an electrical outlet, a cooking device, and a home monitoring device.

11. The method of claim 6, wherein the computer response to the reception of the control commands includes controlling an application running on the computer.

12. A method for operating a computer remotely, comprising:
providing for the logical coupling of a hand-held device to the computer;
providing for the reception on the hand-held device of a user interface for operating the computer; and
providing for the transmission of a control command from the hand-held device to the computer, whereby the computer responds to the control command.

13. The method of claim 12, wherein providing for the logical coupling of a hand-held device to the computer includes equipping the hand-held device with a wireless network access component for accessing a wireless network.

14. The method of claim 12, wherein providing for the reception of the user interface includes providing for the reception of a user interface transmitted from the computer.

15. The method of claim 14, wherein providing for the reception of a user interface from the computer occurs by programming the hand-held device to execute a version of Terminal Services.

16. The method of claim 12, wherein providing for the transmission of a control command from the hand-held device includes providing for a transmission of a command inputted via a user on the hand-held device to the computer via the network.

17. The method of claim 12, wherein providing for the transmission of a control command includes providing for a file transmission request, whereby a file from the computer is transmitted to the hand-held device in response to the file transmission request.

18. A hand-held device programmed to perform the steps recited in the method of claim 12.

19. A method for controlling components coupled to a computer, comprising:
logically coupling a hand-held device to the computer;
establishing a user interface on the hand-held device for controlling the components; and
issuing control commands from the hand-held device whereby the device responds to the issuing of the control commands.

20. A system for remotely controlling a computer, comprising:
a computer equipped with a transceiving device;
a hand-held device logically coupled to the computer;
a server application for transceiving commands to and from the hand-held device; and
a client application for transceiving commands to and from the server computer, whereby a plurality of components are controlled via commands issued from the hand-held device.

21. A hand-held device-readable medium with hand-held device-executable instructions embedded theron for remotely controlling a computer, which when executed perform the steps comprising:
logically coupling the a hand-held device to the computer;
displaying on the hand-held device a user interface for operating the computer; and
transmitting a control command from the hand-held device to the computer whereby the computer responds to the control command.

22. The hand-held device-readable medium of claim 21, wherein the step of logically coupling the hand-held device to the computer includes establishing a connection between the hand-held device and the computer via a wireless network.

23. The hand-held device-readable medium of claim 21, wherein the step of displaying the user interface on the hand-held device includes receiving a graphical user interface transmitted from the computer.

24. The hand-held device-readable medium of claim 21, wherein the step of displaying the user interface on the hand-held device includes executing a user interface presentation module locally on the hand-held device.

25. The hand-held device-readable medium of claim 21, wherein the step of transmitting a control command from the hand-held device includes transmitting a command entered by a user at the hand-held device to the computer.

26. The hand-held device-readable medium of claim 25, wherein the computer response to the reception of the control commands includes controlling one of the plurality of components to the computer.

27. The hand-held device-readable medium of claim 25, wherein the computer response to the reception of the control commands includes controlling an application running on the computer.

28. The hand-held device-readable medium of claim 25, wherein the computer response to the reception of the control commands includes transmitting a file from the computer to the hand-held device.

29. A computer-readable medium having computer-executable instructions embodied thereon for remotely controlling components coupled to a computer, the computer-readable instructions, comprising:
code for logically coupling a hand-held device to the computer;
code for presenting a user interface on the hand-held device for controlling the components;
code for receiving control commands transmitted from the hand-held device, whereby the computer responds to the reception of the control commands.

30. The computer-readable medium of claim 29, wherein code for logically coupling a hand-held device to the computer comprises:
code for enabling the computer to be connected to a network; and
code for enabling the hand-held device to be connected to the network.

31. The computer-readable medium of 30, wherein code for enabling the computer to be connected to a network includes code for enabling the computer to be connected to a wireless network.

32. The computer-readable medium of claim 29, wherein code for presenting the user interface on the hand-held device includes:
code for running a server application on the computer for transmitting a user-interface to the hand-held device and for receiving commands from the hand-held device; and
code for running a client application on the hand-held device for receiving the user interface and transmitting commands to the computer.

33. A method in a computing network environment for controlling components coupled to a computer using a personal data assistant (PDA), comprising:
establishing a wireless link between the computer and the PDA;
running a control application on the computer that controls the components coupled to the computer, the control application having a user interface; and
transmitting the user interface to the PDA whereby inputs made at the PDA control the components.

34. A method for operating home-entertainment equipment using a Pocket PC device, comprising:
coupling the home-entertainment equipment to a personal computer;
establishing a wireless link between the personal computer and the Pocket PC device;
launching a home-entertainment equipment-control application having a user interface on the computer; and
receiving the user interface at the Pocket PC device, whereby inputs made at the Pocket PC device control the home-entertainment equipment.
